(19) United States
(12) Patent Application Publication
(10) Pub. No.: US 2015/0156249 A1
(43) Pub. Date: Jun. 4, 2015

(54) PROVIDING NOTIFICATIONS REGARDING THE MULTICAST OF SCHEDULED CONTENT OR POPULAR CONTENT

(71) Applicant: Verizon Patent and Licensing Inc., Arlington, VA (US)

(72) Inventors: Sagiv Draznin, Walnut Creek, CA (US); Lalit R. Kotecha, San Ramon, CA (US); Matthew W. Nelson, Pleasanton, CA (US)

(73) Assignee: VERIZON PATENT AND LICENSING INC., Arlington, VA (US)

(21) Appl. No.: 14/097,177

(22) Filed: Dec. 4, 2013

(51) Int. Cl. H04L 29/08; H04L 12/18

(52) U.S. Cl. CPC H04L 67/10; H04L 12/189; H04L 12/1895

(57) ABSTRACT

One or more server devices may determine a measure of popularity of multiple content items; select particular content to be provided via a multicast channel when the measure of popularity of the particular content satisfies a threshold; generate a notification regarding the availability of the particular content; and provide the notification to one or more user devices for display on the one or more user devices to notify respective users regarding the availability of the content. The notification may be received by the one or more user devices outside of a multicast control channel. The one or more servers may transmit the particular content via the multicast channel.

### BACKGROUND

Mobile wireless devices, such as smart phones, tablet computing devices, netbooks, etc., may include communication devices that can receive content (e.g., video content, audio content, etc.) from a content provider. The mobile wireless devices connect to a wireless network, such as a cellular network, to receive the content from the content provider.

When providing content, such as video content, over a wireless network, it may be important to intelligently deliver the content to the mobile devices to limit strain on the wireless network. For example, multicast broadcast techniques may be used to provide content to multiple mobile devices over a single channel. In contrast, with a unicast transmission, content transmitted to multiple mobile devices may require multiple channels that are each dedicated to a single mobile device.

While multicasting can limit strain on the wireless network, end users may not be aware of content that is being multicasted. As a result, users may end up requesting content outside of a multicast broadcast of the content (e.g., before or after a multicast broadcast of the content). When the content is requested outside of a multicast broadcast, the content may be transmitted to each mobile device of each end user via individual unicast channels, thereby consuming additional network resources in relation to when the content is provided via a multicast broadcast over a single channel. Also, multicasting unpopular content may waste multicast broadcast resources.

### BRIEF DESCRIPTION OF THE DRAWINGS

FIGS. 1A-1B illustrate an example overview of an implementation described herein;

FIG. 2 illustrates an example environment in which systems and/or methods, described herein, may be implemented;

FIG. 3 is a diagram illustrating an example implementation of portions of the environment shown in FIG. 2;

FIG. 4 illustrates an example data structure that may be stored by one or more devices in the environment of FIG. 2;

FIG. 5 illustrates a flowchart of an example process for identifying popular content and arranging for the popular content to be multicasted;

FIG. 6 illustrates a flowchart of an example process for multicasting content based on receiving a multicast instruction;

FIGS. 7-8 illustrate example implementations as described herein; and

FIG. 9 illustrates example components of one or more devices, according to one or more implementations described herein.

### DETAILED DESCRIPTION OF THE PREFERRED EMBODIMENTS

The following detailed description refers to the accompanying drawings. The same reference numbers in different drawings may identify the same or similar elements.

Systems and/or methods, as described herein, may provide a link between a messaging system and a multicast broadcast system (e.g., a Multimedia Broadcast Multicast Service (MBMS) and/or an enhanced Multimedia Broadcast Multicast Service (eMBMS)) to provide a notification regarding a multicast broadcast of content. Further, the systems and/or methods may identify particular content to be multicasted (e.g., audio, video, an image, an application, an update to an application, or the like) based on browsing activity, content access activity, and/or a request, received from a content provider, to multicast the particular content.

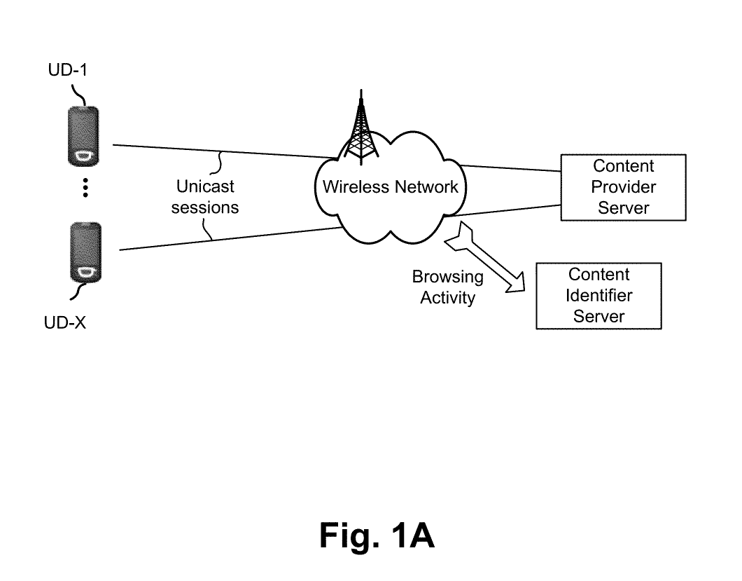

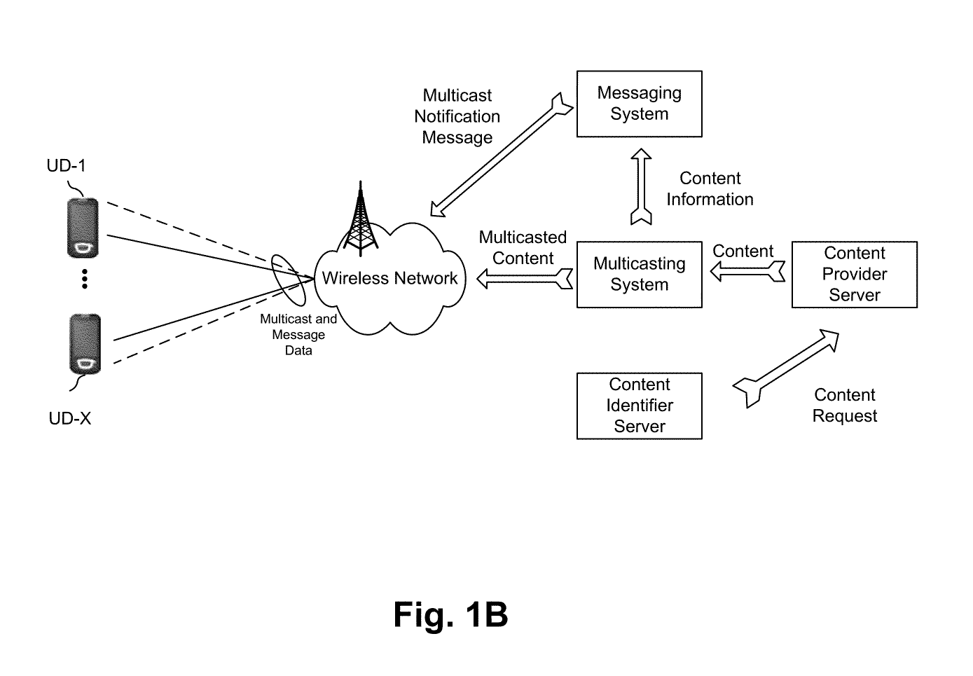

FIGS. 1A-1B illustrate an example overview of an implementation described herein. As shown in FIG. 1A, multiple user devices (UD-1 through UD-X, where X≧1), may independently access a content provider server via a wireless network. In FIGS. 1A-1B, assume that the multiple user devices access the same particular content from the content provider server within a particular period of time. In some implementations, each of the multiple user devices may receive the particular content from the content provider server via independent unicast sessions. In some implementations, a content identifier server may receive browsing activity information (e.g., information relating to user content viewing by users) from one or more components of the wireless network.

In some implementations, the browsing activity information may identify that the multiple user devices receive the particular content from the content provider server within a particular period of time. Based on the browsing activity information, the content identifier server may determine a measure of popularity associated with the particular content and may arrange for the particular content to be multicasted when the measure of popularity satisfies a particular threshold. By multicasting the particular content, network resources can be saved in relation to when the particular content is provided to user devices via individual unicast sessions associated with each user device.

Referring to FIG. 1B, multiple user devices (UD-1 through UD-X, where X≧1), may receive multicast and message data provided over a single channel. As shown in FIG. 1B, the content identifier server may provide a content request to the content provider server based on determining that the measure of popularity of the particular content satisfies the threshold. In some implementations, the content request may direct the content provider server to provide the particular content to a multicasting system such that the content may be multicasted to multiple user devices (e.g., UD-1 through UD-X). Based on receiving the particular content, the multicasting system may provide content information regarding the particular content to a messaging system.

In some implementations, the content information may identify attributes of the particular content (e.g., a description, a title, a tag, information identifying a geographic location associated with the particular content, information identifying a type of the particular content, such as video, music, a public announcement, etc.). Based on the information regarding the content information, the messaging system may provide a multicast notification message to one or more of UD-1 through UD-X to notify respective users that the particular content is available.

In some implementations, the messaging system may provide the multicast notification to particular user devices based on the attributes of the particular content and based on user subscriptions, profiles, and/or preferences that identify types of content that a user may wish to receive. For example, when the attributes of the particular content include tags that describe the particular content (e.g., the tags “cats” and “dancing”), a group of user devices associated with users having interests in the subject of cats and/or dancing (e.g., based on user profile information, user subscription information, user preference information, etc.) may receive the multicast notification. A user device may present the notification to the user and receive an indication from the user of whether the user wishes to view the particular content. In some implementations, the user device may immediately receive the content. Alternatively, the content may be scheduled to be transmitted to the user device at a later time.

As described herein, currently popular content (e.g., content accessed greater than a threshold number of times within a particular time period, such as viral videos, breaking news, etc.) may be made available to user devices via multicast channels, thereby reducing network load relative to using unicast sessions to transmit content. Further, notifications regarding the availability of multicasted content may be provided such that users may be made aware of the availability of the multicasted content.

Also, particular content to be multicasted may be selected based on a measure of popularity associated with the particular content. Additionally, or alternatively, particular content to be multicasted may be selected based on a request for the content to be multicasted at a particular time and for user devices associated with a particular subscription, regardless of popularity (e.g., to multicast live events, a television show, or the like). Additionally, or alternatively, a content provider may request content to be multicasted for content relating to an emergency message, a public announcement, an update to an application, or the like.

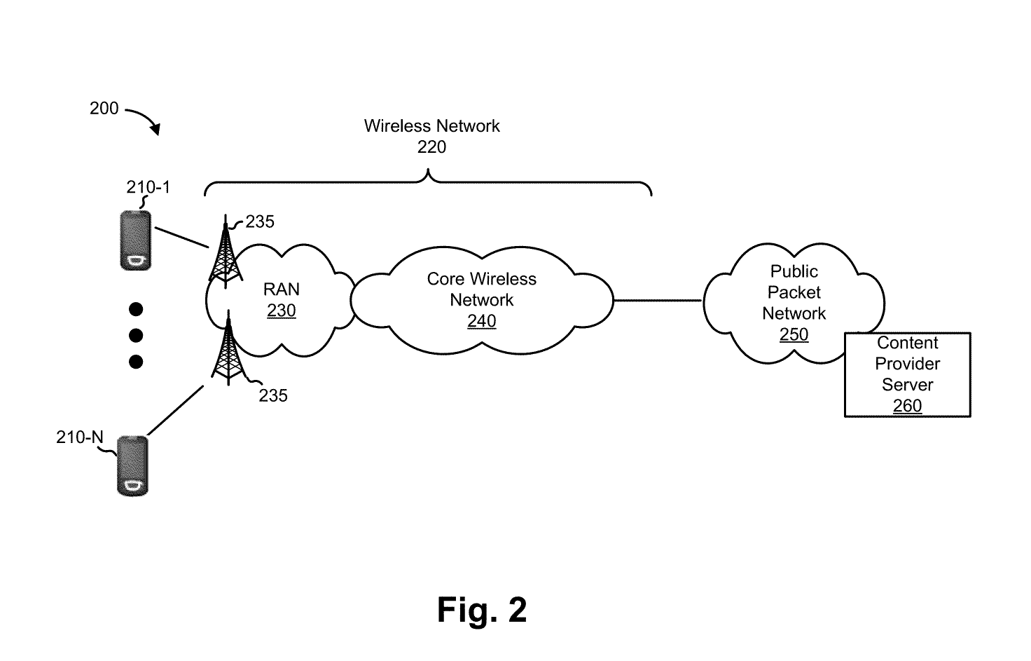

FIG. 2 is a diagram of an example environment 200 in which systems and/or methods described herein may be implemented. As shown in FIG. 2, environment 200 may include user devices 210-1, . . . , 210-N (where N≧1), wireless network 220, core wireless network 240, public packet network 250, and content provider 260. User device 210 may obtain network connectivity through wireless network 220 (e.g., a cellular network). Wireless network 220, as illustrated, may include radio access network (RAN) 230 and core wireless network 240.

One or more additional networks, such as a public packet network 250, may connect to core wireless network 220. Content provider 260 may include one or more devices, such as content servers, that deliver content (e.g., streaming audio or video) to user devices 210. The content, from content provider 260, may be delivered, over RAN 230, as multicast content.

User device 210 may include a portable computing and/or communication device, such as a personal digital assistant (PDA), a smart phone, a cellular phone, a laptop computer with connectivity to a cellular wireless network, a tablet computer, etc. User device 210 may also include a non-portable computing device, such as desktop computer, consumer or business appliance, set-top device, and/or another device that may connect to RAN 230. User device 210 may connect, through a radio link, to RAN 230. Through the radio link, user device 210 may obtain data and/or voice services, such as content delivery services via which content (e.g., streaming video, streaming audio, or other content) may be delivered to user device 210. In some implementations, one or more user devices 210 may simultaneously receive multicasted content via an application, such as a media streaming application, an application updater, or the like.

RAN 230 may provide wireless connectivity for wireless network 220. RAN 230 may include, for example, one or more base stations 235. Each base station 235 may provide one or more radio interfaces over which the base station may communicate with user devices 210. The radio interfaces may include, for example, orthogonal frequency-division multiplexing (OFDM) and/or single-carrier frequency-division multiple access (SC-FDMA) based radio interfaces. In the context of a network such as a long term evolution (LTE) network, base stations 235 may be referred to as evolved Node Bs (eNodeBs).

Core wireless network 240 may implement a network that provides routing, control, and data transmission services for user devices 210. Core wireless network 240 may connect to one or more other networks, such as to packet network 250, to provide network services to user devices 210. Core wireless network 240 may include one or more network devices used to implement control logic, physical links, and routing/switching functions that may be performed by core wireless network 240. In one implementation, core wireless network 240 may implement an LTE network.

Packet network 250 may include one or more packet networks, such as an Internet Protocol (IP) based packet network. Public packet network 250 may include a wide area network (WAN), a local area network (LAN), and/or combinations of WANs and LANs. User devices 210 may access packet network 250 to obtain computation and/or data services from computing devices, such as from content provider 260.

Content provider 260 may include one or more server devices that provide content, such as on-demand video content, to user devices 210. A content provider 260 may, for example, be an entity that has the rights to provide television content, other video content, radio content, etc. Content provider 260 may provide content, destined for user device 210, via packet network 250 and wireless network 220. As mentioned above, some of the content provided by content provider 260 may be multicast to multiple user devices 210.

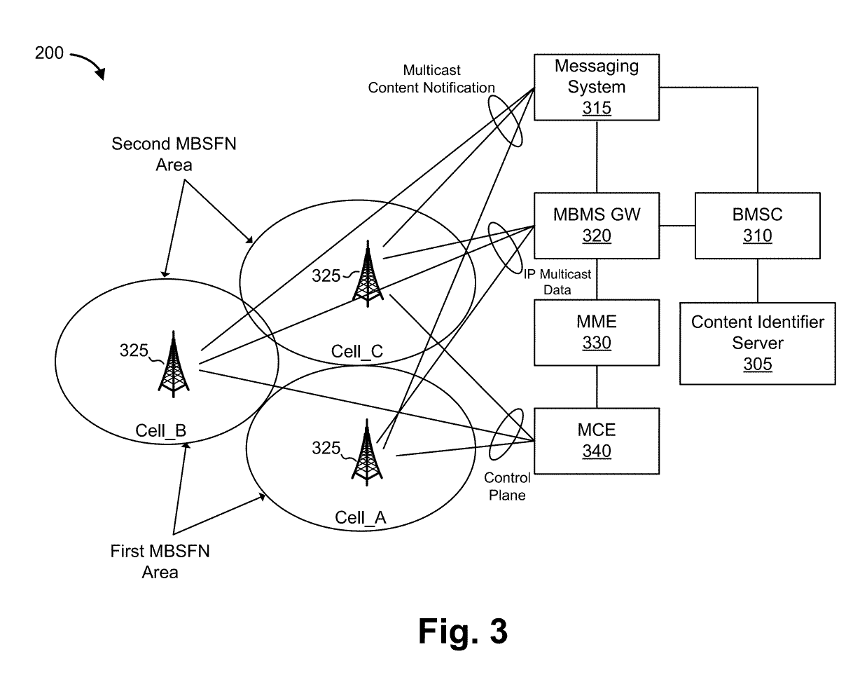

FIG. 3 is a diagram illustrating an example implementation of portions of environment 200. In FIG. 3, elements of wireless network 220 may be particularly illustrated for an LTE network. In the context of an LTE network, multicast may be implemented as an eMBMS service. In other possible implementations, the functionality corresponding to the portions of environment 200 that are illustrated in FIG. 3 may be implemented based on other standards or technologies.

As shown in FIG. 3, an eMBMS service may be implemented using content identifier server 305, broadcast multicast service center (BMSC) 310, messaging system 315, MBMS Gateway (MBMS GW) 320, Mobility Management Entity device (MME) 330, and Multi-cell/multicast Coordination Entity (MCE) 340. The eMBMS service may be provided to a number of wireless cells, labeled as Cell_A, Cell_B, and Cell_C. Each cell may be associated with a corresponding eNodeB 325.

Content identifier server 305 may include one or more computation or communication devices that receive network activity (e.g., browsing activity, content selection activity, etc.), associated with user device 210, from one or more components of core wireless network 240. In some implementations, content identifier server 305 may determine a measure of popularity of content provided by content provider server 260 to user devices 210 and may identify particular content that is to be multicasted based on the measure of popularity. For example, content identifier server 305 may determine the measure of popularity based on a quantity of user devices 210 that access the particular content within a particular time period, an average portion of the content that is received by user devices 210, and/or based on some other information derived from the network activity. Additionally, or alternatively, content identifier server 305 may determine a measure of popularity of the particular content based on user ratings, messages regarding the particular content posted on social networking websites, etc. In some implementations, content identifier server 305 may provide a content request to content provider server 260 to provide the particular content to BMSC 310 for multicast transmission (e.g., once content identifier server 305 has identified the particular content to be multicasted).

BMSC 310 may include one or more computation or communication devices that provide for the coordination of multicast using eMBMS. BMSC 310 may perform functions relating to authorization, charging, and assignment of communication channels. For example, BMSC 310 may assign a particular number of multicast data channels for various multicast content streams. BMSC 310 may also receive content (e.g., from content provider 260), and may forward the received content as part of a multicast transmission.

In some implementations, BMSC 310 may maintain a multicast schedule to identify when content is to be multicasted. In some implementations, the multicast schedule may be selected by an administrator and/or an owner of the content. For example, content can be multicasted at a time corresponding to a broadcast schedule of the content (e.g., for a television show that is to be broadcast at a particular time and/or for a live event). Additionally, or alternatively, the content can be immediately multicasted when content identifier server 305 identifies popular content.

BMSC 310 may further identify particular user devices 210 that may be permitted to receive the content based on attributes of the content. BMSC 310 may provide notification information to messaging system 315 identifying notification messages regarding content that is to be multicasted. In some implementations, BMSC 310 may provide information identifying attributes of the content to messaging system 315.

Messaging system 315 may include one or more computation or communication devices that receive information identifying attributes of content that is to be multicasted. In some implementations, messaging system 315 may generate a message based on the attributes and may provide the message to particular user devices 210 (e.g., via MBMS GW 320 and/or base stations 235). In some implementations, messaging system 315 may provide the message as a short message service (SMS) text message, a multimedia message service (MMS) message, a push notification using a push messaging service, a packet-based message, and/or some other type of message. In general, the message may be a message transmitted outside of a multicast control channel. As described in greater detail below, the message may notify a user of user device 210 regarding content available to be received by user device 210. Further, the message may be provided outside of a multicast control channel and may be presented for display on user device 210.

MBMS GW 320 may include one or more computation or communication devices that provide for the coordination of the sending of multicast data (e.g., IP multicast packets) to base stations 235. MBMS GW 320 may receive the content, which is to be multicast, from BMSC 310. As illustrated, MBMS GW 320 may transmit eMBMS data plane traffic (“IP Multicast Data”) to eNodeBs 325. In some implementations, MBMS GW 320 may also provide message data (e.g., corresponding to messages generated by messaging system 315).

MME 330 may include one or more computation and communication devices that may perform operations relating to registering user devices 210 with the LTE network, the hand off user devices 210 from/to another network, and to policing operations on traffic destined for and/or received from user devices 210.

MCE 340 may include one or more computation or communication devices that may perform admission control, allocation of radio resources throughout a Multimedia Broadcast Multicast Service Single Frequency Network (MBSFN) area, MBMS session control signaling, and make decisions on radio configurations. As illustrated, MCE 340 may transmit eMBMS control plane traffic (“Control Plane”) to eNodeBs 325.

In eMBMS, cells associated with eNodeBs 325 may be grouped to obtain MBSFN areas. Multicast data channels in a MBSFN area may be synchronized so that identical multicast radio signals may be generated, at the same time, for multiple cells. For example, MBSFN areas may be defined that cover the area associated with multiple ones of the illustrated cells. For example, a first MBSFN area may correspond to the area covered by Cell_A and Cell_B. A multicast data channel, transmitted in the first MBSFN area, may include radio signals that are synchronized in Cell_A and Cell_B. A second MBSFN area may correspond to the area covered by Cell_B and Cell_C.

Although FIGS. 2 and 3 illustrate example components of environment 200, in other implementations, environment 200 may contain fewer components, different components, differently arranged components, or additional components than those depicted. Alternatively, or additionally, one or more components of environment 200 may perform one or more other tasks described as being performed by one or more other components of environment 200.

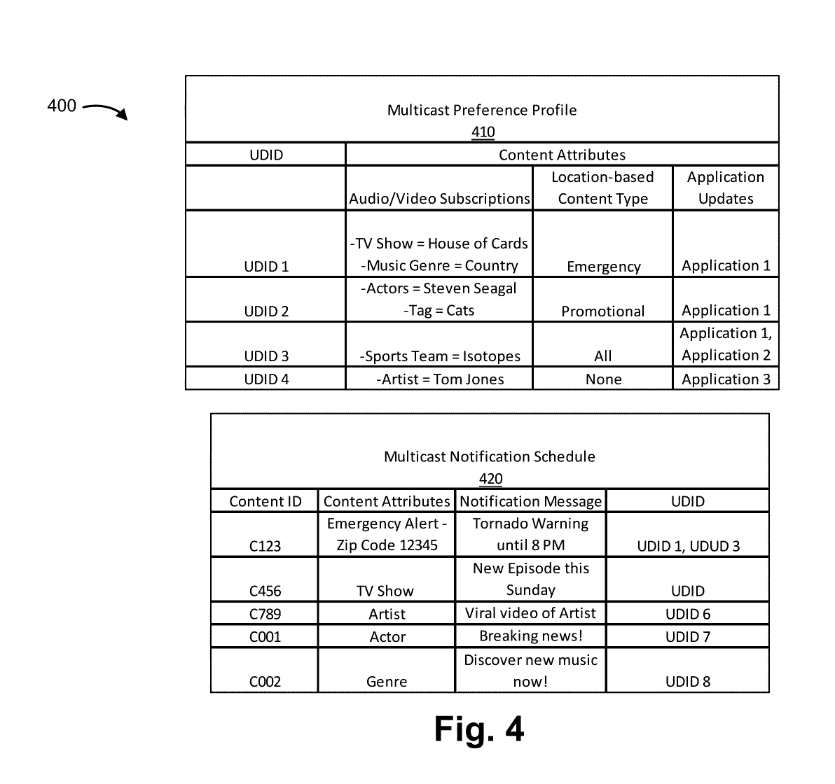

FIG. 4 illustrates an example data structure 400 that may be stored by one or more devices in environment 200, such as messaging system 315. In some implementations, data structure 400 may be stored in a memory of messaging system 315. In some implementations, data structure 400 may be stored in a memory separate from, but accessible by, messaging system 315 (e.g., a “cloud” storage device). In some implementations, data structure 400 may be stored by some other device in environment 200, such as BMSC 310, MBMS GW 320, MME 330, and/or MCE 340.

A particular instance of data structure 400 may contain different information and/or fields than another instance of data structure 400. As shown in FIG. 4, data structure 400 may include multicast preference profile 410 and multicast notification schedule 420.

Multicast preference profile 410 may include information identifying types of multicast content that a user may wish to receive based on attributes of the multicast content. For example, each entry in multicast preference profile 410 may identify a user device identifier (UDID) associated with a user and the attributes of multicast content that the user may wish to receive via a particular user device 210 associated with the UDID. In some implementations, multicast preference profile 410 may identify attributes relating to user subscriptions (e.g., subscriptions to particular television shows, genres, actors, tags, etc.), types of content (e.g., location-based emergency content, location-based promotional content, content relating to application updates for particular applications, etc.). In some implementations, user device 210 may receive notifications regarding the availability of multicast content having the attributes identified in multicast preference profile 410.

In an example shown in FIG. 4, multicast preference profile 410 may identify that user device 210 (e.g., associated with the UDID “UDID 1”) may receive notifications regarding the availability of multicast content associated with the television show “House of Cars,” and the music genre “Country.” Further, user device 210 may receive notifications regarding the availability of location-based emergency multicast content, and the availability of multicast content relating to an update of the application “Application 1.”

Multicast notification schedule 420 may store information identifying content to be multicasted by BMSC 310 from content provider server 260 (e.g., an identifier of the content, a link to the content, attributes of the content, etc.). Multicast notification schedule 420 may further store a notification message associated with the content. In some implementations, the notification message may be selected by an administrator and/or an owner of the content and may include a description of the content and/or a notification as to when the content is available to be received by user device 210. For example, as described above, the content may be immediately available when content identifier server 305 identifies popular content (e.g., a popular video clip, live event, etc.). Additionally, or alternatively, the content may be available in accordance with a broadcast schedule (e.g., corresponding to the broadcast of a television show, a live event, etc.), an application release schedule (e.g., for content relating to the release of an application and/or application update), etc.

Multicast notification schedule 420 may further identify UDIDs of user devices 210 that may receive a notification associated with particular content. For example, the UDIDs may be based on the attributes of the content and information stored by multicast preference profile 410 identifying types of content that a particular user, associated with user device 210, may be interested in receiving. As an example, assume that the content having the content ID “C123” is an emergency alert type content associated with the geographic location corresponding to the zip code “12345.” Further, assume that multicast preference profile 410 stores information identifying that the user device 210 having the UDID “UDID 1” is to receive location-based emergency alert type content. Further, assume that the user device 210 having the UDID “UDID 1” is located in a geographic location corresponding to the zip code “12345.” Given these assumptions, multicast notification schedule 420 may store information to identify that a notification message regarding content “C123” is to be provided to the user device 210 having the UDID “UDID 1.”

In some implementations, user device 210 may receive the notification message, and may receive a selection to receive the content (e.g., from a user of user device 210 via an application and/or user interface). If the content is immediately available, user device 210 may receive the content via a multicast session. If the content is to be available at a later time, user device 210 may receive a selection to schedule receipt of the content when the content is available via the multicast session. If the content is immediately available, but user device 210 is unable to receive the content (e.g., when a signal strength of a signal connecting user device 210 to RAN 230 is below a particular threshold), user device 210 may schedule to receive the content at a later time (e.g., via a unicast session at an off-peak time or via a multicast session when the content is later transmitted via the multicast session).

While particular fields are shown in a particular format in data structure 400, in practice, data structure 400 may include additional fields, fewer fields, different fields, or differently arranged fields than are shown in FIG. 4. Also, FIG. 4 illustrates examples of information stored by data structure 400. In practice, other examples of information stored by data structure 400 are possible.

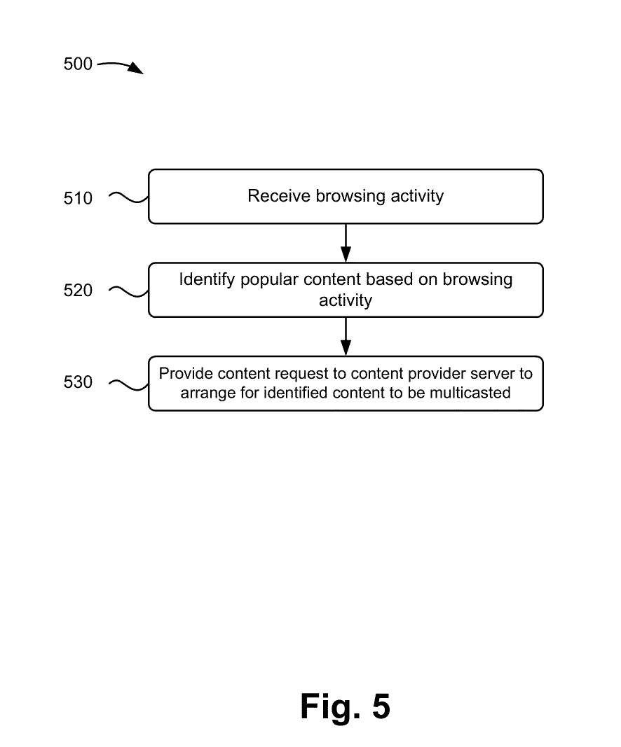

FIG. 5 illustrates a flowchart of an example process 500 for identifying popular content and arranging for the popular content to be multicasted. In one implementation, process 500 may be performed by one or more components of content identifier server 305. In another implementation, some or all of blocks of process 500 may be performed by one or more components of another device in environment 200 (e.g., BMSC 310, messaging system 315, MBMS GW 320, MME 330, and/or MCE 340), or a group of devices including or excluding content identifier server 305.

As shown in FIG. 5, process 500 may include receiving browsing activity (block 510). For example, content identifier server 305 may receive browsing activity, relating to content viewing by users, from one or more components of core wireless network 240. In some implementations, the browsing activity may identify information associated with data flows between user devices 210 and content provider server 260. The browsing activity may identify content that user devices 210 request and receive from content provider server 260, for example, based on header information in packets of the data flows.

Process 500 may also include identifying popular content based on the browsing activity (block 520). For example, content identifier server 305 may determine a measure of popularity of content that is requested and/or received by user devices 210. In some implementations, the measure of popularity may be based on a number of user devices 210 that access particular content within a particular amount of time (e.g., as identified by the browsing activity). Additionally, or alternatively, the measure of popularity may be based on some other information (e.g., user feedback regarding content, user ratings information, user interest information provided by users via social networking websites, etc.).

In some implementations, content identifier server 305 may identify content in which the measure of popularity satisfies the threshold. In some implementations, the threshold may be a fixed threshold selected by an administrator. Additionally, or alternatively, the threshold may be determined based on a particular number of standard deviations above an average measurement of popularity. Additionally, or alternatively, the threshold may be determined using some other technique.

Process 500 may further include providing a content request to the content provider server to arrange for the identified content to be multicasted (block 530). For example, content identifier server 305 may provide a request to content provider server 260 to provide the identified content to BMSC 310. As described in greater detail below, BMSC 310 may receive the content and may prepare the content for multicasting. In some implementations, content identifier server 305 may provide a multicast instruction to BMSC 310. In some implementations, the multicast instruction may direct BMSC 310 to multicast the content within a particular amount of time of receiving the content such that the content can be multicasted, thereby reducing network load in relation to when the content is delivered via individual unicast sessions. For example, for audio/video type content, the multicast instruction may direct BMSC 310 to multicast the content within one minute, two minutes, or within some other amount of time (e.g., such that a user may have time to select to receive the content prior to when the multicast begins for the audio/video type content).

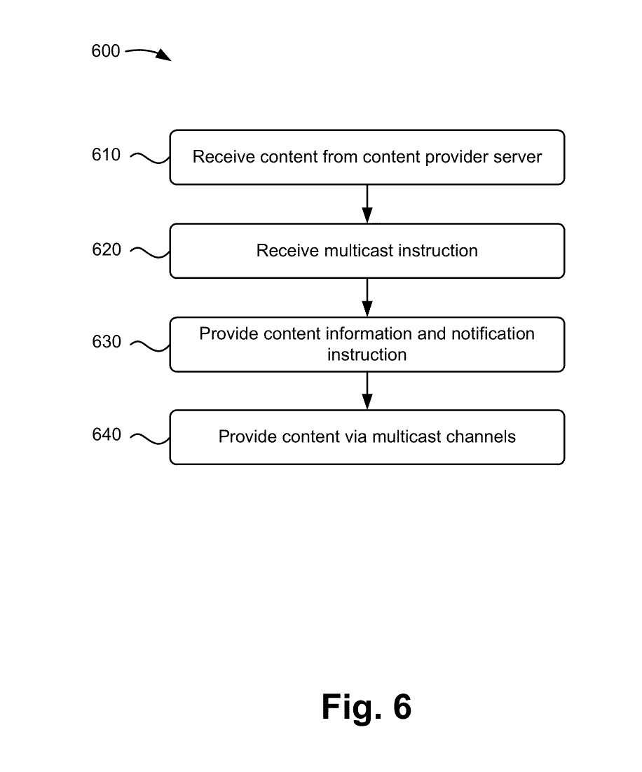

FIG. 6 illustrates a flowchart of an example process 600 for multicasting content based on receiving a multicast instruction. In one implementation, process 600 may be performed by one or more components of BMSC 310. In another implementation, some or all of blocks of process 600 may be performed by one or more components of another device in environment 200 (e.g., content identifier server 305, messaging system 315, and/or MBMS GW 320), or a group of devices including or excluding BMSC 310.

As shown in FIG. 6, process 600 may include receiving content from a content provider server (block 610). For example, BMSC 310 may receive the content from content provider server 260. In some implementations, content identifier server 305 may request content provider server 260 to provide the content to BMSC 310 when content identifier server 305 identifies that the content is to be multicasted (e.g., based on a measure of popularity). In some implementations, an administrator and/or owner of the content may request content provider server 260 (e.g., via a user interface, a web portal, etc.) to provide the content to BMSC 310 so that the content can be multicasted.

Process 600 may also include receiving a multicast instruction (block 620). For example, BMSC 310 may receive the multicast instruction from content identifier server 305 and/or from content provider server 260. In some implementations, the multicast instruction may include an instruction to multicast the content at a particular time and to particular user devices 210 (e.g., based on information stored by multicast preference profile 410 that identifies user devices 210 whose users may be interested on receiving the content). In some implementations, the multicast instruction may include a notification message regarding the availability of the content, a description of the content, etc.

In some implementations, the multicast instruction may be provided by content identifier server 305 and may direct BMSC 310 to begin multicast of the content within a particular period of time. For example, when content identifier server 305 identifies content that has been accessed greater than a threshold number of times within a threshold time period, content identifier server 305 may provide a multicast instruction to direct BMSC 310 to begin multicast of the content such that the content may be received by user devices 210 via multicast channels instead of via individual unicast session. As a result, currently popular content (e.g., content accessed greater than a threshold number of times within a particular time period, such as viral videos, breaking news, etc.) may be made available to user devices 210 via multicast channels, thereby reducing network load in relation to when the popular content is accessed via individual unicast sessions.

In some implementations, the multicast instruction may be provided by an administrator and/or content owner. For example, the multicast instruction may direct BMSC 310 to multicast the content at a particular time in accordance to a broadcast schedule of the content (e.g., when the content is a television show, a live event, etc.). As a result, content may be made available to user devices 210 via multicast channels at a time that corresponds to a broadcast schedule of the content to permit users to view the content on user devices 210.

Process 600 may further include providing content information and a notification instruction (block 630). For example, BMSC 310 may provide the content information (e.g., information identifying content attributes) and notification instruction (e.g., including a notification that is to be provided to user devices 210) to messaging system 315. Based on receiving the content information and the notification instruction, messaging system 315 may generate multicast notification schedule 420 based on the content attributes and information stored by multicast preference profile 410. Further, messaging system 315 may provide notifications to the user devices 210, identified in multicast notification schedule 420, and whose users have selected to receive notifications regarding content that meet particular attributes. In some implementations, user device 210 may display the notification and may present an option that the user may select to receive the content.

In some implementations, content identifier server 305 may receive responses to the notification (e.g., from user devices 210 that received the notification), such as requests to receive the content and/or responses to decline receiving the content. Based on the responses to the notifications, content identifier server 305 may refine a measure of popularity associated with the content and may generate multicast instructions to modify the transmission of the content based on the refined measure of popularity. For example, content identifier server 305 may generate an instruction to repeat multicast of the content when the measure of popularity has been increased based on the responses. Additionally, or alternatively, content identifier server 305 may generate an instruction to multicast the content at a higher or lower resolution, or to cancel the multicast of the content when the refined measure of popularity drops below a particular threshold.

In some implementations, messaging system 315 may provide popularity measurement queries to the user devices 210 and may receive responses to the popularity measurement queries in order to measure popularity associated with particular content. For example, a content owner may provide a request to messaging system 315 to provide a popularity measurement query to user devices 210 in order to measure popularity of particular content based on responses to the messages received. As an example, a popularity measurement query may include a query that users may respond to, such as “Interested in watching new documentary featuring cat?” Based on responses to the popularity measurement query, content identifier server 305 may determine a measure of popularity of particular content with the popularity measurement query and arrange for the particular content to be multicasted by requesting the particular content to be provided to BMSC 310.

Process 600 may also include providing the content via multicast channels (block 640). For example, BMSC 310 may provide the content to MBMS GW 320 at a time identified in the multicast instruction in order to multicast the content as described above with respect to FIG. 3. In some implementations, user device 210 may receive multicasted content via an application (e.g., an audio/video streaming application, or the like). For example, a user may select the application to receive the content based on receiving a notification identifying that the content is available. Additionally, or alternatively, the user may select the application at any time to select and receive content that is currently being multicasted.

While FIGS. 5-6 shows processes 500-600 as including a particular quantity and arrangement of blocks, in some implementations, processes 500-600 may include fewer blocks, additional blocks, or a different arrangement of blocks. Additionally, or alternatively, some of the blocks may be performed in parallel.

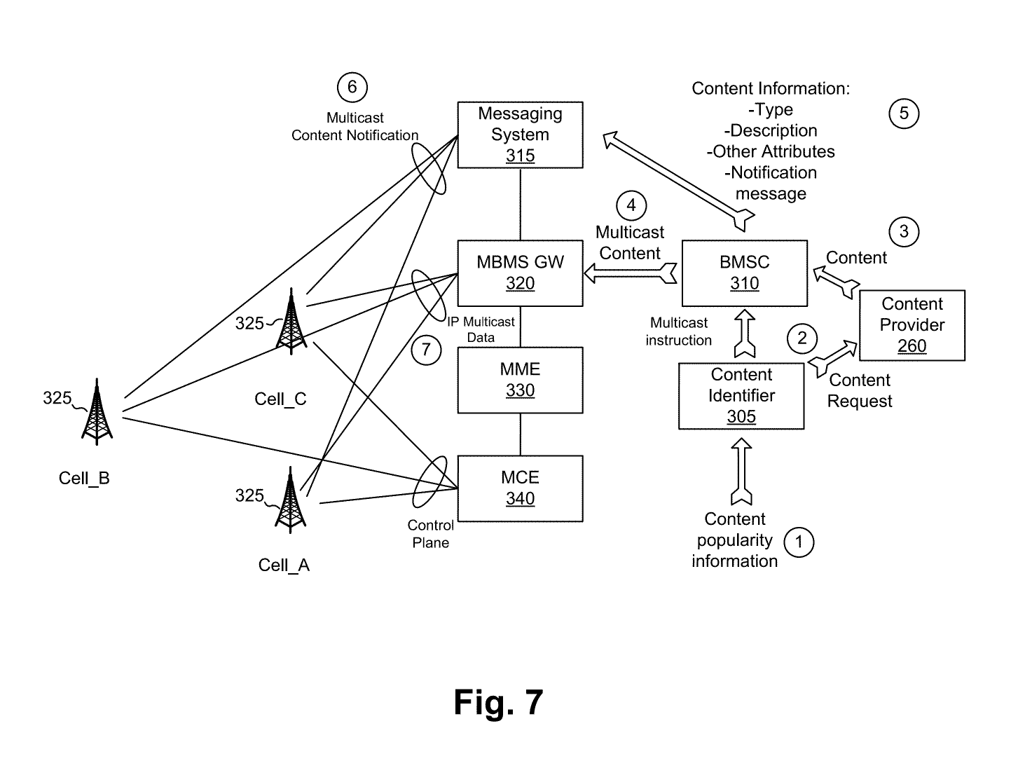

FIG. 7 illustrates an example implementation as described herein. As shown in FIG. 7, content identifier server 305 may receive content popularity information (1) and may select content to be multicasted based on the content popularity information (e.g., a number of times that content is accessed within a particular period of time, indicating currently popular content). After selecting the content, content identifier server 305 may provide a request for the content (2) to content provider server 260 to request content provider server 260 to provide the selected content to BMSC 310 (3). Content identifier server 305 may further provide a multicast instruction to BMSC 310 to direct BMSC 310 to multicast the content at a particular time, such as within 1 minute, 2 minutes, 5 minutes, or within some other time of receiving the content (e.g., such that currently popular content may be multicasted when the currently popular content is identified while allowing for time for a user to view the content when the multicast of the content begins).

As further shown in FIG. 7, BMSC 310 may provide the content for multicast (4) to MBMS GW 320 at a particular time in accordance with the multicast instruction. BMSC 310 may further provide content information (5) to messaging system 315. Messaging system 315 may receive the content information, generate multicast notification schedule 420 based on the content information and information stored by multicast preference profile 410, and may provide multicast content notifications (6) in accordance with multicast notification schedule 420. Based on receiving the multicast content, MBMS GW 320 and/or MCE 340 may provide IP multicast data and control plane data (7) in order to multicast the content via one or more cells 325.

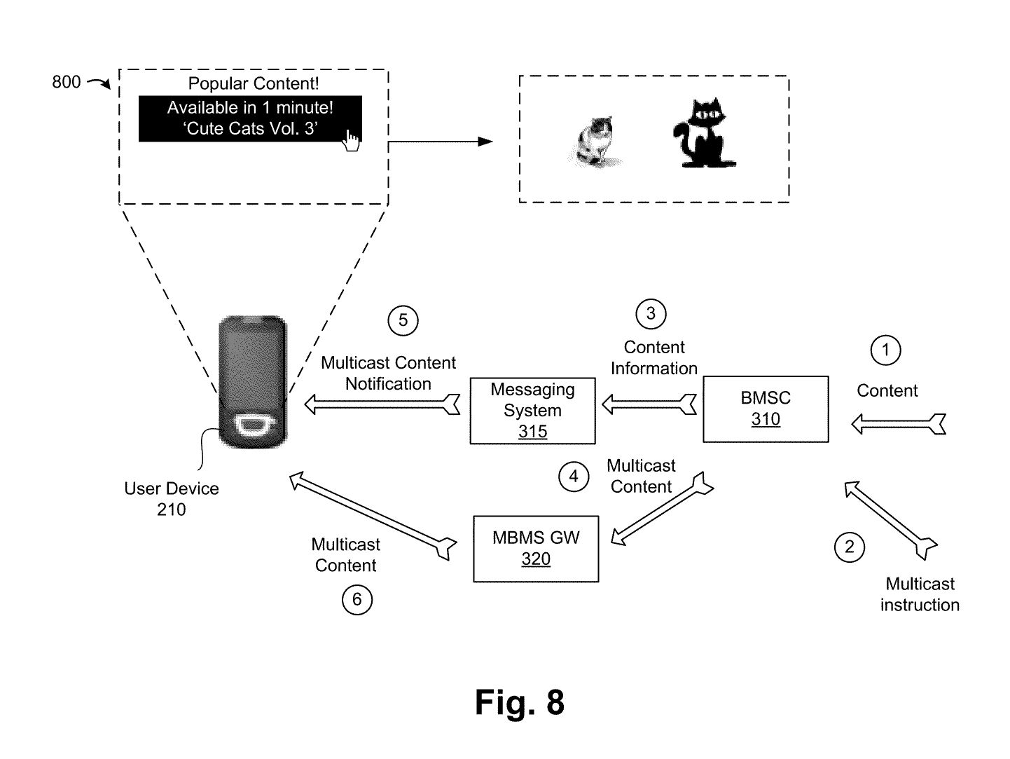

Referring to FIG. 8, assume that BMSC 310 receives content (1) selected by content identifier server 305 and relating to a popular video (e.g., a video that has been accessed greater than a threshold number of times within a particular time period). Further, assume that BMSC 310 receives a multicast instruction (2) to multicast the video at a particular time, such as one minute from when the content was selected by content identifier server 305. Further, assume that the multicast instruction includes a notification, such as “Popular Content! Available in 1 minute! ‘Cute Cats Vol. 3.’” Given these assumptions, BMSC 310 may provide content information to messaging system 315 (3) and the content to be multicast (4) to MBMS GW 320.

As further shown in FIG. 8, messaging system 315 may provide a multicast content notification (5) to user device 210 based on receiving the content information and identifying that user device 210 is to receive a notification regarding the availability of the content (e.g., based on the content information and information stored by multicast preference profile 410 that indicates a user of user device 210 has selected to receive notifications of content having the attributes identified in the content information). For example, assume that the content information includes a tag or description of the content, such as a tag relating to the subject of “cats.” Further, assume that information stored by multicast preference profile 410 identifies that a user of the user device 210 shown in FIG. 8 has selected to receive notifications regarding content relating to the subject of “cats.” Given these assumptions, messaging system 315 may provide the notification to user device 210 to notify the user that content relating to the subject of “cats” will be made available to user device 210.

As further shown in FIG. 8, user device 210 may present the notification in a user interface (e.g., interface 800). In some implementations, the notification may be presented as a push notification, an SMS message, an MMS message, an e-mail, or the like. Based on receiving the notification, user device 210 may receive a selection to receive the multicasted content (e.g., when the user selects an application that may identify multicasted content and permit the user to select particular multicasted content). As a result, the user may receive a notification of content that the user may be interested in received (e.g., based on selections made by a user and corresponding to a user profile, user interest information, subscription information, etc., stored by multicast preference profile 410). Further, the content may be provided to user device 210 via multicast channels, thereby saving network resources in relation to when the content is provided via a unicast session.

While particular examples are shown in FIGS. 7-8 the above description is merely an example implementation. In practice, other examples are possible from what is described above in FIGS. 7-8.

As described above, currently popular content (e.g., content accessed greater than a threshold number of times within a particular time period, such as viral videos, breaking news, etc.) may be made available to user devices 210 via multicast channels, thereby reducing network load in relation to when the popular content is accessed via individual unicast sessions. Further, notifications regarding the availability of multicasted content may be provided such that users may be made aware of the availability of the multicasted content and receive the multicasted content via a multicast broadcast instead of via individual unicast sessions.

Also, particular content to be multicasted may be selected based on a measure of popularity associated with the particular content. Additionally, or alternatively, particular content to be multicasted may be selected based on request for the content to be multicasted at a particular time and for user devices associated with a particular subscription, regardless of popularity (e.g., to multicast live events, a television show, or the like). Additionally, or alternatively, a content provider may request content to be multicasted for content relating to an emergency message, a public announcement, an update to an application, or the like.

In some implementations, user device 210 may present (e.g., via an application and/or user interface) content that is currently being multicasted to permit a user to select particular multicasted content. For example, the user may select the application based on receiving a notification indicating that multicasted content that the user may be interested in receiving is available. Additionally, or alternatively, the user may select the application to receive multicast content in accordance with a broadcast schedule (e.g., to receive content corresponding to a television show, a live event, etc.). In some implementations, the content may be provided to user device 210 via multicast channels based on a signal strength of a signal connecting user device 210 and RAN 230. If the signal strength of the signal is below a particular threshold, user device 210 may schedule to receive the content at a later time (e.g., via a unicast session at an off-peak time or via a multicast session when the content is later transmitted via the multicast session).

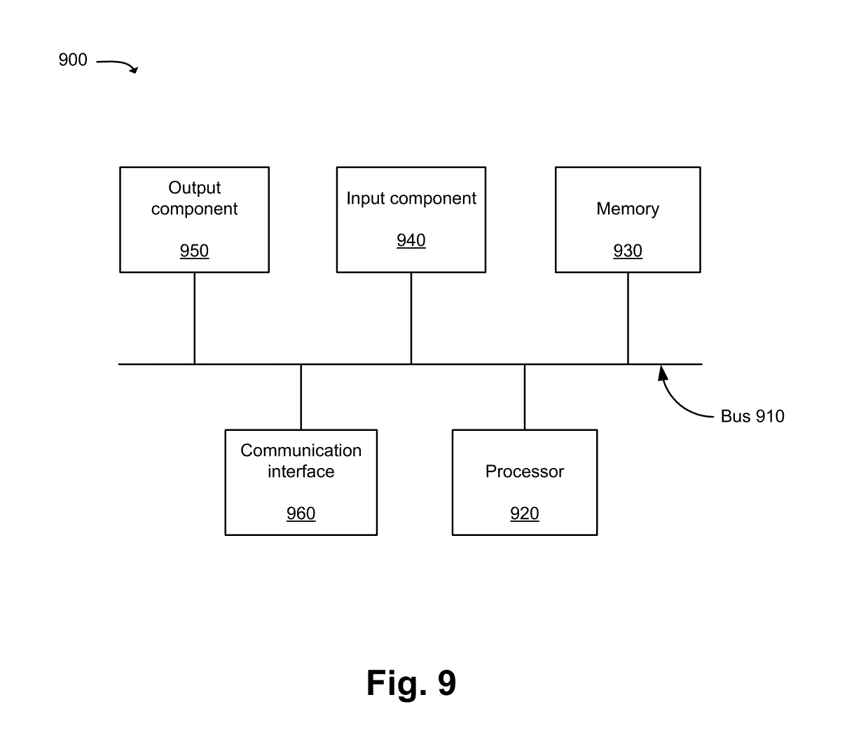

FIG. 9 is a diagram of example components of device 900. One or more of the devices described above (e.g., with respect to FIGS. 1A-1B, 2-3, and 7-8) may include one or more devices 900. Device 900 may include bus 910, processor 920, memory 930, input component 940, output component 950, and communication interface 960. In another implementation, device 900 may include additional, fewer, different, or differently arranged components.

Bus 910 may include one or more communication paths that permit communication among the components of device 900. Processor 920 may include a processor, microprocessor, or processing logic that may interpret and execute instructions. Memory 930 may include any type of dynamic storage device that may store information and instructions for execution by processor 920, and/or any type of non-volatile storage device that may store information for use by processor 920.

Input component 940 may include a mechanism that permits an operator to input information to device 900, such as a keyboard, a keypad, a button, a switch, etc. Output component 950 may include a mechanism that outputs information to the operator, such as a display, a speaker, one or more light emitting diodes (“LEDs”), etc.

Communication interface 960 may include any transceiver-like mechanism that enables device 900 to communicate with other devices and/or systems. For example, communication interface 960 may include an Ethernet interface, an optical interface, a coaxial interface, or the like. Communication interface 960 may include a wireless communication device, such as an infrared (“IR”) receiver, a Bluetooth® radio (Bluetooth is a registered trademark of Bluetooth SIG, Inc.), radio, or the like. The wireless communication device may be coupled to an external device, such as a remote control, a wireless keyboard, a mobile telephone, etc. In some embodiments, device 900 may include more than one communication interface 960. For instance, device 900 may include an optical interface and an Ethernet interface.

Device 900 may perform certain operations relating to one or more processes described above. Device 900 may perform these operations in response to processor 920 executing software instructions stored in a computer-readable medium, such as memory 930. A computer-readable medium may be defined as a non-transitory memory device. A memory device may include space within a single physical memory device or spread across multiple physical memory devices. The software instructions may be read into memory 930 from another computer-readable medium or from another device. The software instructions stored in memory 930 may cause processor 920 to perform processes described herein. Alternatively, hardwired circuitry may be used in place of or in combination with software instructions to implement processes described herein. Thus, implementations described herein are not limited to any specific combination of hardware circuitry and software.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Some implementations are described herein in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
receiving, by one or more servers, content that is to be provided via a multicast channel;
generating, by the one or more servers, a notification regarding the availability of the content;
providing, by the one or more servers, the notification to one or more user devices for display on the one or more user devices to notify respective users regarding the availability of the content,
the notification being transmitted by the one or more servers outside of a multicast control channel;
receiving, by the one or more servers, information regarding a measure of popularity of the content;
selecting, by the one or more servers, a particular resolution of the content based on the measure of popularity; and
transmitting, by the one or more servers and to the one or more user devices, the content at the selected resolution and via the multicast channel.

2. (canceled)

3. The method of claim 1, further comprising:
providing one or more popularity measurement queries to the one or more user devices; and
receiving responses to one or more popularity measurement queries,
wherein the measure of popularity of the content item is based on the responses to the one or more popularity measurement queries.

4. The method of claim 1, further comprising:
receiving one or more responses to the notification from the one or more user devices,
wherein transmitting the content is based on receiving the one or more responses to the notification.

5. (canceled)

6. The method of claim 1, further comprising:
identifying the one or more user devices that are to receive the notification based on attributes of the content,
wherein providing the notification is based on identifying the one or more user devices that are to receive the notification.

7. The method of claim 1, wherein providing the content via the multicast channel includes providing the content in accordance with a broadcast schedule.

8. The method of claim 1, further comprising:
receiving a multicast instruction,
the multicast instruction identifying a time to provide the content via the multicast channel; and
wherein providing the content via the multicast channel includes providing the content via the multicast channel at the time identified in the multicast instruction;
wherein the notification identifies the time when the content is available.

9. A system comprising:
one or more server devices configured to:
determine a measure of popularity of a plurality of content items;
select particular content, to be provided via a multicast channel, when the measure of popularity of the particular content satisfies a threshold;
generate a notification regarding the availability of the particular content;
provide the notification to one or more user devices for display on the one or more user devices to notify respective users regarding the availability of the content,
the notification being transmitted by the one or more servers outside of a multicast control channel;
transmit the particular content via the multicast channel; and
retransmit the particular content at an interval, the interval being based on the measure of popularity of the particular content.

10. (canceled)

11. The system of claim 9, wherein the one or more server devices are further to:
receive one or more responses to the notification from the one or more user devices,
wherein when transmitting the content, the one or more server devices are further to transmit the content based on receiving the one or more responses to the notification.

12. The system of claim 9, wherein the one or more server devices are further to:
identify the one or more user devices that are to receive the notification based on attributes of the content,
wherein when providing the notification, the one or more server devices are further to provide the notification to the one or more user devices based on identifying the one or more user devices that are to receive the notification.

13. The system of claim 9, wherein the one or more server devices are further to:
receiving a multicast instruction identifying a time to provide the content via the multicast channel; and
wherein when providing the content via the multicast channel, the one or more server devices are further to provide the content via the multicast channel at the time identified in the multicast instruction;
wherein the notification identifies the time when the content is available.

14. The system of claim 9, wherein providing the content via the multicast channel includes providing the content in accordance with a broadcast schedule.

15. A method comprising:
determining, by one or more devices, a measure of popularity of content;
selecting, by the one or more devices, the content, to be provided via a multicast channel, when the measure of popularity satisfies a threshold;
generating, by the one or more devices, a notification regarding the availability of the selected content;
providing, by the one or more devices, the notification to one or more user devices for display on the one or more user devices to notify respective users regarding the availability of the content,
the notification being transmitted by the one or more servers outside of a multicast control channel;
transmitting, by the one or more devices, the selected content via the multicast channel; and
retransmitting, by the one or more devices, the particular content at an interval, the interval being based on the measure of popularity of the particular content.

16. (canceled)

17. The method of claim 15, further comprising:
receiving one or more responses to the notification from the one or more user devices,
wherein transmitting the content is based on receiving the one or more responses to the notification.

18. The method of claim 15, further comprising:
identifying the one or more user devices that are to receive the notification based on attributes of the content,
wherein providing the notification includes providing the notification to the one or more user devices based on identifying the one or more user devices that are to receive the notification.

19. The method of claim 15, further comprising:
receiving a multicast instruction,
the multicast instruction identifying a time to provide the content via the multicast channel; and
wherein when providing the content via the multicast channel, the one or more server devices are further to providing the content via the multicast channel at the time identified in the multicast instruction;
wherein the notification identifies the time when the content is available.

20. The method of claim 15, wherein providing the content via the multicast channel includes providing the content in accordance with a broadcast schedule.

21. The method of claim 1, further comprising:
retransmitting the content at an interval, the interval being based on the measure of popularity of the content.

22. The system of claim 9, where the one or more servers are further to:
select a particular resolution of the particular content based on the measure of popularity, wherein when transmitting the particular content, the one or more server devices are further to transmit the particular content at the particular resolution.

23. The method of claim 15, further comprising:
selecting a particular resolution of the particular content based on the measure of popularity,
wherein when transmitting the particular content includes transmitting the particular content at the particular resolution.
